(19) United States
(12) Patent Application Publication
(10) Pub. No.: US 2026/0071862 A1
(43) Pub. Date: Mar. 12, 2026

(54) APPARATUS AND METHOD FOR MEASURUING BORE HOLE DEPTH

(71) Applicant: AQUIRIAN TECHNOLOGY PTY LTD, Perth, Western Australia (AU)

(72) Inventors: Jonathan WRIGHT, Perth (AU); Gregory PATCHING, Perth (AU)

(21) Appl. No.: 19/106,156

(22) PCT Filed: Aug. 24, 2023
(86) PCT No.: PCT/AU2023/050818

§ 371 Date: Feb. 24, 2025

(30) Foreign Application Priority Data
Aug. 25, 2022 (AU) 2022902437

(51) Int. Cl. G01B 3/1003; E21B 47/04

(52) U.S. Cl. CPC G01B 3/1004; E21B 47/04

(57) ABSTRACT

The invention relates to an apparatus for measuring a depth of a bore hole. The apparatus includes an elongated strip including linear measurement markings along at least a portion of a length of the strip. A weight is provided at an end of the strip and the strip is comprised of material that has an elastic (Young's) modulus of greater than 0.5 and less than 2.0 GPa. Embodiments of the invention are adapted to quickly and effectively measure the depth of a bore hole or a depth to any major obstructions such as loose rocks that may have fallen into the bore hole.

### TECHNICAL FIELD

The present invention relates to the field of bore hole drilling. In particular, the present invention relates to bore hole drilling in relation to mining and quarrying but it is to be appreciated that the invention may have broader application such as in relation to excavation and piling.

### BACKGROUND

Above ground open cut mining is a method often employed to recover minerals such as iron ore and coal. Such methods can involve the use of blasting with bulk explosives to dislodge bulk quantities of ore for excavation and recovery through subsequent handling via excavators. The blasting process results in the comminution of rock containing the ore into particles of varying sizes. It is desirable for the blasting process to produce material with an average particle size that is as small as possible so as to minimise the need for further comminution by crushing, grinding, vibrating and other processes.

Bench blasting is a process that involves drilling a pattern of bore holes and filing the bore holes with explosive material to forming a column charge that fractures the rock in a controlled manner. The bore holes are drilled by a drill rig comprising mobile platform with an upright mast for supporting a drill string comprising lengths of drill pipe connected together and a cutting head. The bore holes drilled by the drilling rig can have diameters as large as 270 to 311 or even up to 350 millimetres and larger and have depths of as much as 50 metres or more. These bore holes are filled with bulk explosive materials that are, at least in part, ammonium nitrate based explosives. The explosive material will be contacted with a primer and covered or “stemmed” with material such as aggregate. The primer is activated by an electrically or, non-electrically or electronic detonator or by some other means to thereby cause the explosive to detonate.

The drill rig displays an indication to the operator of the depth of the bore hole. Accordingly, when the drill rig indicates that the desired depth has been reached the operator will stop drilling. The operator will cause the drill string to be withdrawn from the bore hole. It is critical to measure the depth of each bore hole, also referred to as ‘dipping the bore hole’, to ensure that it conforms to the desired depth and to ensure that the bore hole has not been obstructed by loose rocks that may have fallen into the bore hole (‘fall back’) and either obstructed the bore hole (‘bridging’) or reduced its depth. If the bore hole does not measure to the required depth then the internal volume of the bore hole available to be filled with explosive material will not meet the specified depth of the blast design or plan.

An existing method for measuring the depth of bore holes includes using a device known as a ‘dip tape’. A typical dip tape consists of a length of measuring tape comprising a ribbon of plastic or glass fibers coated with PVC with linear measurement markings with a weight attached to an end of the tape. Often a ‘surveyors tape’ is used as these come in relatively long lengths of 30 metres or more.

There exists some task specific dip tape solutions consisting of a long roll of flexible tape with linear measurement markings that are cut to size. Another existing dip tape includes a flexible plastic rope with linear measurement markings. There also exist some specially sized weights for attachment to the end of a dip tape and in other instances a heavy weight such as a rock may be attached to the end of the dip tape within electrical tape.

Existing dip tapes have a number of drawbacks. Often the dip tape gets tangled and can be time consuming for an operator to untangle which slows the bore hole drilling and blasting operation. Existing dip tapes have a propensity for getting caught in the bore hole and sometimes they break and need replacing which again slows the bore hole drilling and blasting operation. The material used for existing dip tapes is relatively weak and prone to breaking or wearing away with use. Accordingly, a need exists for a dip strip that ameliorates some or all of the abovementioned problems with existing dip tape solutions.

Any discussion of background art throughout the specification should in no way be considered as an admission that any of the documents or other material referred to was published, known or forms part of the common general knowledge.

### SUMMARY OF THE INVENTION

Accordingly, in one aspect, the invention provides an apparatus for measuring a depth of a bore hole, the apparatus including:
an elongated strip comprised of material that has an elastic (Young's) modulus of greater than 0.5 and less than 2.0 GPa (gigapascals);
a weight at an end of the strip; linear measurement markings along at least a portion of a length of the strip.

The depth of the bore hole that is being measured by embodiments of the apparatus can include a depth to the bottom of the bore hole. The depth being measured may be a depth to any major obstructions such as loose rocks that may have fallen into the bore hole and reduced the effective depth of the bore hole. The depth being measured may be the depth to any major obstruction within the bore hole that has reduced the effective depth of the bore hole or that would otherwise prevent an amount of explosive material from being loaded into the bore hole, and to the required depth, that accords with the blast design or plan.

Embodiments of the apparatus are suitable for use in conveniently and efficiently determining if reinsertion of a drill string into a bore hole is necessary to remove an obstruction or to continue drilling the bore hole deeper to the required depth.

Preferably, the material has an elastic (Young's) modulus of between 1.6 and 1.7 GPa (gigapascals).

In embodiments, the material has an elastic (Young's) modulus of greater than 0.5, or greater than 0.8, or greater than 1.0, or greater than 1.2, or greater than 1.4 GPa (gigapascals).

In embodiments, the material having an elastic (Young's) modulus of less than 5.0, or less than 4.0, or less than 3.0, or less than 2.0 GPa (gigapascals).

Preferably, the material has an elastic (Young's) modulus of between about 1.0 and 1.9 GPa (gigapascals) or preferably between about 1.3 and 1.8 GPa (gigapascals).

In preferred embodiments, the elongated strip comprises, in cross-section, a height of about 4 mm and a width of about 14.5 mm.

The flexibility and stiffness of the strip is a function of the material from which the strip is formed and the physical dimensions of the strip. It has been found that the combination of features of the strip wherein the material has an elastic (Young's) modulus of between 1.6 and 1.7 GPa (gigapascals) and comprises, in cross-section, a height of about 4 mm and a width of about 14.5 mm, results in the elongated strip comprising a desired compromise between stiffness and flexibility so that in use the apparatus, including the strip and weight at an end thereof, can be fed down to the bottom of a bore hole relatively quickly and effectively and without getting caught on relatively minor obstructions or in cracks in the wall of the bore hole.

It has been found that the above combination of features of the strip wherein the strip has a length of 20 metres, the material has an elastic (Young's) modulus of between 1.6 and 1.7 GPa (gigapascals) and comprises, in cross-section, a height of about 4 mm and a width of about 14.5 mm, and wherein the weight is about 500 grams comprises a particularly preferred compromise of features such that the strip and weight at an end thereof, can be fed down to the bottom of a bore hole relatively quickly and effectively and without getting caught on relatively minor obstructions or in cracks in the wall of the bore hole.

Preferably, the measurement markings are comprised of indicia that are recessed into a surface of the strip.

In preferred embodiments, the indicia are recessed by a depth of about 0.25 mm, or about 0.50 mm, or about 0.75 mm, or about 1.00 mm, or about 1.25 mm, or about 1.50 mm, or any increment therebetween, into the surface of the strip.

In further preferred embodiment, the indicia are defined by a surface recessed within an outer surface of the strip.

In still yet further preferred embodiments, the recessed surface is covered with a visible coating.

Preferably, the weight is permanently fixed to the end of the strip.

In embodiments, the weight includes an elongated body comprising a distal end and a proximal end, wherein the proximal end includes a central opening extending longitudinally within the weight for receiving the end of the strip therewithin.

In preferred embodiments, the strip includes one or more apertures for fixing the weight to the strip.

In embodiments, the one or more apertures in the strip engage with one or more detents located within the central opening of the weight.

In embodiments, the apertures in the strip are adapted for receiving fasteners for fixing the weight to the strip.

In embodiments, the material forming the weight flows into the one or more apertures in the strip thereby fix the weight to the strip. In embodiments, the material forming the weight flows into the one or more apertures in the strip from pressure, or heat, or a combination thereof, applied to the material forming the weight.

In yet further preferred embodiments, the proximal end and the distal end are rounded, wherein the rounding of the distal end has a larger radius than the rounding of the proximal end.

In still yet further preferred embodiments, the weight is comprised of a soft metal, preferably lead or an alloy with properties similar to lead.

Preferably, the body of the weight is covered with a coating of material, preferably of plastic or of rubber or of rubber-like material.

In another aspect, the invention provides a method of drilling a bore hole and of measuring a depth of the bore hole, the method including:
locating a drilling apparatus at the location of a bore hole to be drilled;
drilling a bore hole using a drill string of the drilling apparatus comprising an assembly of drill pipes and a cutting bit;
inserting a measuring apparatus into the bore hole including an elongated strip with a weight at and end of the strip, wherein the strip is comprised of material that has an elastic (Young's) modulus of greater than 0.5 and less than 2.0 GPa (gigapascals); and
reading a depth of the bore hole by determining visually which one of a plurality of linear measurement markings along a length of the strip is located closest to a lip surrounding an opening of the bore hole.

In other embodiments, the measuring apparatus is inserted into the bore hole when the drill string is removed from the bore hole

### BRIEF DESCRIPTION OF THE FIGURES

The present invention will now be described in more detail with reference to preferred embodiments illustrated in the accompanying figures, wherein:

FIG. 1 illustrates a side view of an apparatus for measuring the depth of a bore hole including an elongated strip of material rolled up into a reel and a weight at the end of the strip including linear measurement markings along the length of the strip;

FIG. 2 illustrates a top view of a portion of the length of the elongated strip of the apparatus of FIG. 1 illustrating in greater detail the linear measurements along the length thereof;

FIG. 3 illustrates a cross section view of the strip of the apparatus of FIG. 1;

FIG. 4 illustrates a side view of a longitudinal cross section of the weight of the apparatus of FIG. 1;

FIG. 5 illustrates an end view of the weight of the apparatus of FIG. 1;

FIG. 6 illustrates a side view of the apparatus of FIG. 1 in use for measuring the depth of a bore hole;

FIG. 7 illustrates a side view of the apparatus of FIG. 1 in use for measuring the depth of the bore hole, wherein the weight at the end of the strip has reached the bottom of the bore hole.

### DETAILED DESCRIPTION

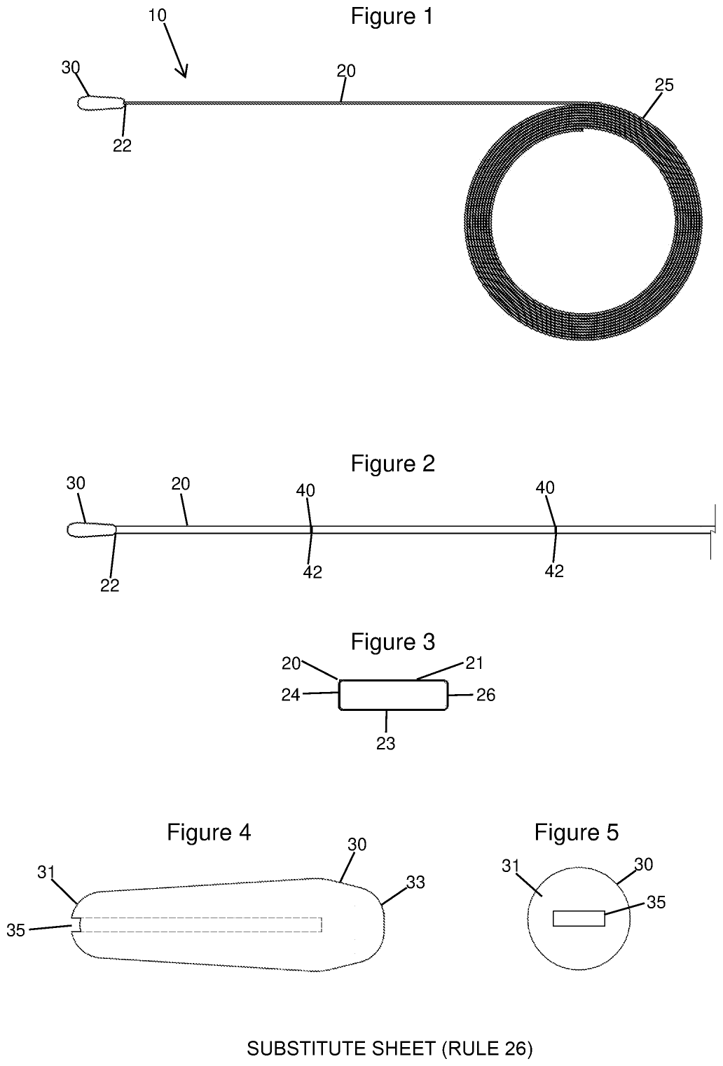

Referring to FIGS. 1 to 7, there is shown an apparatus 10 for measuring the depth of a bore hole 2. The apparatus 10 includes an elongated strip 20 and a weight 30 at an end 22 of the strip 20. The strip 20 including linear measurement markings 40 along at least a portion of a length of the strip 20. The strip 20 has a relatively long length as required and in exemplary embodiments is 7 metres, 12 metres, 20 metres, 30 metres, 40 metres or 50 metres in length. As illustrated in FIG. 1, due to its length, the strip 20 is rolled into a reel 25 for storage.

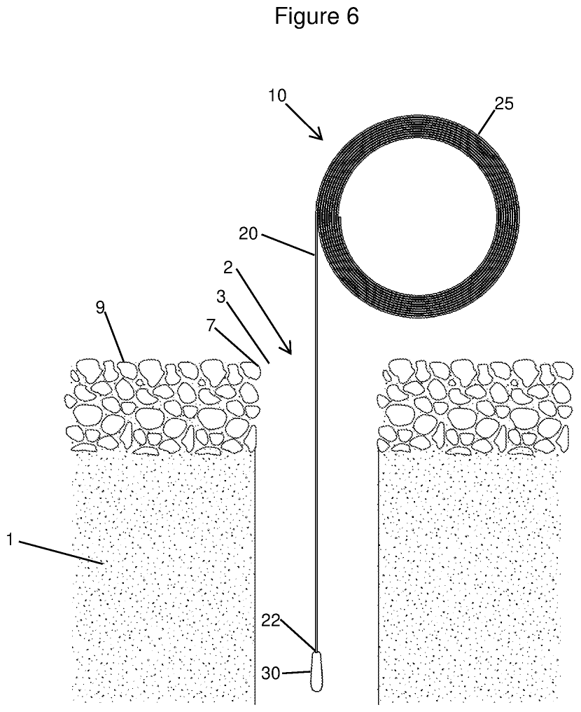

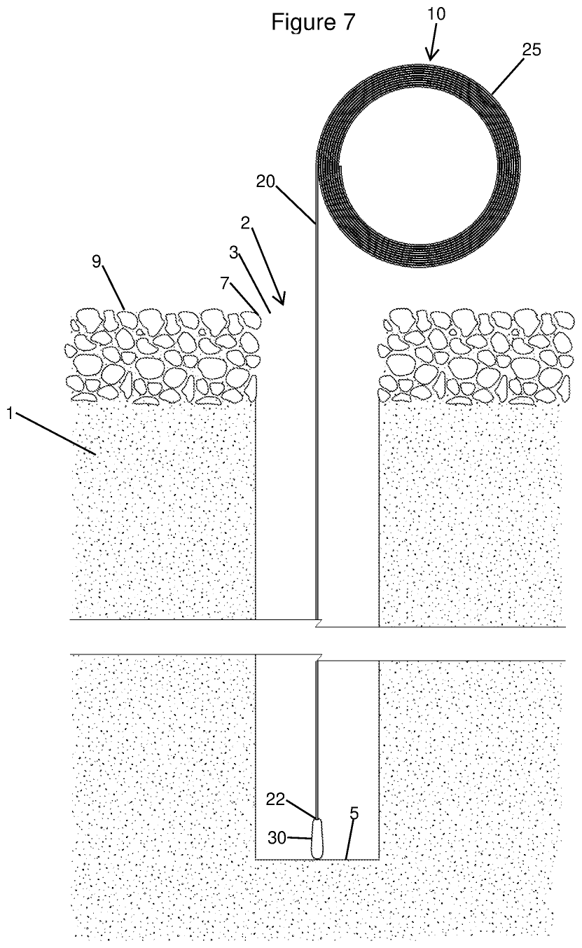

In use, as illustrated in FIGS. 6 and 7, the apparatus 10 is adapted for measuring the depth of the bore hole 2 to ensure that it conforms to the desired depth. If the bore hole 2 is not the required depth then the internal volume of the bore hole 2 may not conform to the blast design or plan. The apparatus 10 is useful for ensuring that the depth of the bore hole 2 accords with the blast design or plan so that the correct amount of explosive material is provided into the bore hole 2 and to the required depth.

In embodiments, the strip 20 is to some extent flexible but is also relatively stiff and resistant to bending. Put another way, the strip 20 is more stiff than existing dip tapes used for measuring the depth of bore holes 2. The strip 20 is to some extent flexible but is more stiff than existing dip tapes comprising a ribbon of plastic or glass fibers coated with PVC, an example of which is ‘surveyors tape’.

The flexibility and stiffness of the strip 20 is a function of the material from which the strip 20 is formed and the physical dimensions of the strip 20. In embodiments, the strip 20 is formed of material having an elastic (Young's) modulus of greater than 0.5, or greater than 0.8, or greater than 1.0, or greater than 1.2, or greater than 1.4 GPa (gigapascals). In embodiments, the strip 20 is formed out of a material having an elastic (Young's) modulus of less than 5.0, or less than 4.0, or less than 3.0, or less than 2.0 GPa (gigapascals).

Preferably, the material from which the strip 20 is formed includes polypropylene. Preferably, the polypropylene has an elastic (Young's) modulus of between about 1.0 and 1.9 GPa (gigapascals) or preferably between about 1.3 and 1.8 GPa (gigapascals) or preferably between about 1.6 and 1.7 GPa (gigapascals). In embodiments, the strip 20 is formed of solid polypropylene or in other embodiments the polypropylene is reinforced, such as with fibre such as glass fibre. In embodiments, the material from which the strip 20 is formed includes a polypropylene copolymer, preferably a homopolymer, or in another preferred embodiment a random copolymer, or in another preferred embodiment a block copolymer.

FIG. 3 illustrates a cross section of the strip 20. The strip 20 has a substantially rectangular cross section along at least part or along the entire length thereof. The strip 20 has a top surface 21 and a bottom surface 23 and opposite side surfaces 24, 26 extending between the top and bottom surfaces 21, 23. In a preferred embodiment the strip 20 comprises, in cross-section, a height of about 4 mm and a width of about 14.5 mm. As such, the top and bottom surfaces 21, 23 respectively have a width dimension of 14.5 mm and the side surfaces 24, 26 respectively have a height dimension of about 4 mm.

In an alternative embodiment, the strip 20 can comprise a round or an oval cross section along at least part or along the entire length thereof. In embodiments in which the strip 20 has a round cross section it has a diameter of about 4 mm, or about 5 mm, or about 6 mm, or about 7 mm, or about 8 mm or about 9 mm or about 10 mm, or any increment therebetween. In embodiments in which the strip 20 has an oval cross section it has a height of about 4 mm and a width of about 14.5 mm.

In rectangular and oval shaped cross section embodiments, the strip 20 has a width dimension of about 10 mm, or about 11 mm, or about 12 mm, or about 13 mm, or about 14 mm, or about 15 mm, or about 16 mm, or about 17 mm or any increment therebetween. In embodiments, the strip 20 has a height dimension of about 2 mm, or about 3 mm, or about 4 mm, or about 5 mm, or about 6 mm, or about 7 mm, or about 8 mm, or any increment therebetween.

Referring to the rectangular shaped cross section embodiments of the strip 20 illustrated in the Figures, the strip 20 has rounded corners at which the top and bottom surfaces 21, 23 and the side surfaces 24, 26 meet. The rounded corners preferably have a radius of between about 0.25 mm and about 0.50 mm or any increment therebetween.

The material properties of the strip 20 and/or the structural dimensions of the strip 20 mean that the strip 20 is very resistant to becoming tangled. Furthermore, the material properties of the strip 20 and/or the structural dimensions of the strip 20 mean that the strip 20 is resistant to getting caught in the bore hole 2 and/or from breaking and/or from wearing down with repeated use and needing replacing. Furthermore, the structural properties of the strip 20, which are that it has a relatively high Young's modulus (in embodiments between about 1.0 and 1.9 GPa and preferably between about 1.6 and 1.7 GPa) and/or because of the structural dimensions, mean that the strip 20, including the weight 30 at an end 22 of the strip 20, can be fed down to the bottom of the bore hole 20 relatively quickly and effectively and without getting caught on relatively minor obstructions or in cracks in the wall of the bore hole 2.

The aforementioned features that are useful for preventing the strip 20 from being obstructed by relatively minor obstructions from reaching the bottom 5 of the bore hole 2. Accordingly, the material properties of the strip 20 result in the apparatus 10 being operable to measure the depth of the bore hole 2 to ensure that it conforms to the desired depth. The material properties of the strip 20 result in the apparatus 10 being operable to ensure that the bore hole 2 has not been obstructed by any major obstructions such as loose rocks that may have fallen into the bore hole 2 and either obstructed the bore hole 2 or reduced the depth of the bore hole 2.

Referring to FIG. 2, the measurement markings 40 are located at spaced apart locations along at least a portion of the length of the strip 20. The markings 40 include some markings that are located at one metre intervals and include indicia comprising consecutive numerals such as 1, 2, 3, 4 etc through to say 7 metres, 12 metres, 20 metres, 30 metres, 40 metres or 50 metres for a respective 7 metre, 12 metre, 20 metre, 30 metre, 40 metre or 50 metre long strip 20. The markings 40 may also include intermediate markings located at the midpoint between the aforementioned metre spaced markings. Preferably the markings 40 include intermediate markings located at 200 mm intervals between the aforementioned metre spaced markings. The intermediate markings may or may not include any numbering indicia.

The measurement markings 40 are comprised of indicia 42, such as a numeral and/or a line, that are recessed into a surface of the strip 20, preferably the top surface 21 of the strip 20. The indicia 42 are recessed by a depth of about 0.25 mm, or about 0.50 mm, or about 0.75 mm, or about 1.00, or about 1.25 mm, or about 1.50 mm, or any increment therebetween, into the top surface 21 of the strip 20. The indicia 42 are defined by a surface 43 recessed within and below the surrounding surface of the strip 20, for example the top surface 21 of the strip 20. The indicia 42 can be provided in the top surface 21 by mechanical engraving or by a die for mechanically impressing the indicia 42, comprising numerals and/or lines, into the top surface 21 of the strip 20. In another form, the indicia 42 can be provided in the top surface 21 by a method that employs the use of heat to melt the material forming the strip 20. For example, a heated die may be used to form the indicia 42 into the top surface 21 of the strip 20.

The recessed surface 43 that is formed in the top surface 21 of the strip 20 and that comprises an indicia 42 is covered with a visible coating such as a paint, a pigment or a dye. The resulting indicia 42, which are recessed and that include a visible coating within the recess, is less susceptible to being made illegible or unreadable to an operator, even when the strip 20 is covered at least in part with dirt and/or mud.

FIGS. 4 and 5 illustrate enlarged views of the weight 30. FIG. 4 illustrates a side view of a longitudinal cross section of the weight 30 and FIG. 5 illustrates an end view of the weight 30. The weight 30 includes an elongated body 32 comprising a distal end 33 and a proximal end 31. The proximal end 31 includes a central opening 35 extending longitudinally within the body 32. The central opening 35 within the body 32 of the weight 30 receives the end 22 of the strip 20 therewithin. The central opening 35 is dimensioned slightly larger than the external width and height dimensions of the strip 20 to thereby receive the end 22 of the strip 20 in a relatively close fit therewithin.

The weight is formed out of a metal, including lead or an alloy containing lead or another suitably heavy material. The mass of the weight is 500 grams. However, in other embodiments the weight is any increment from between about 200 grams to 1000 grams. In embodiments, in which the strip 20 is in shorter lengths, for example 7 metres or 12 metres, the weight has a relatively lower mass of say about 200 to 400 grams. In embodiments in which the strip is longer in length of say 20 metres or 30 metres, the weight has a relatively higher mass of say about 500 to 700 grams. In embodiments in which the strip is longer in length of say 40 metres or 50 metres in length, the weight has a relatively higher mass of say about 700 to 1000 grams.

The end 22 of the strip 20 includes one or more, or preferably a pair of apertures (not shown), that extend from the top surface 21 to the bottom surface 23 of the strip 20. The apertures are adapted for either receiving fasteners (not shown) or for engagement by one or more detents (not shown) within the central opening 35 of the weight 30. Thus, the weight 30 is fixed to the end 22 of the strip 20.

In another embodiment, the material forming the weight 30 flows into the one or more apertures in the strip 20 to thereby fix the weight 30 to the strip 20. In embodiments, the material forming the weight 30 flows into the one or more apertures in the strip from pressure, or heat, or a combination thereof, applied to the material forming the weight 30.

The proximal end 31 and the distal end 33 of the weight 30 are rounded. The rounding of the distal end 33 has a larger radius than the rounding of the proximal end 31. Accordingly, the body 32 of the weight 30 has more of its mass located closer towards the distal end 33 than the proximal end 21.

The body 32 of the weight 30 is made of a metal. Preferably, the metal is a relatively heavy and soft metal such as lead, or an alloy with properties similar to lead. The body 32 of the weight 30 is also preferably covered with a coating of plastic, preferably polypropylene, or in other embodiments the weight 30 is covered with rubber or rubber-like material that is overmoulded thereto. The coating is adapted to protect the relatively soft metal forming the weight 30 from abrasion. The coating covering the weight 30 can also be operable for reducing the propensity of the weight 30 from being caught or snagged in a bore hole.

Furthermore, the structural properties of the strip 20, which are that it has a relatively high Young's modulus (preferably between about 1.0 and 1.9 GPa) and/or because of the structural dimensions and/or because of the shape and configuration of the weight 30 attached to the end 22 of the strip or a combination of the aforementioned features, mean that the strip 20 can be effectively fed down to the bottom of the bore hole 20 relatively quickly and effectively and without getting caught on relatively minor obstructions or in cracks in the wall of the bore hole 2.

The rounded distal end 33 of the weight 30 reduces the propensity of the apparatus 10 from being caught on relatively minor obstructions or in cracks in the wall of the bore hole 2 as the apparatus 10 is fed down into the bore hole 2. Similarly, the rounded proximal end 31 of the weight 30 reduces the propensity of the apparatus 10 from being caught on relatively minor obstructions or in cracks in the wall of the bore hole 2 as the apparatus 10 is withdrawn from the bore hole 2.

Referring to FIGS. 6 and 7, there is shown a method of use of the apparatus 10. First, as illustrated in FIG. 6, an operator will locate the apparatus above an opening 3 to a bore hole 2 that has already been drilled into rock 1 on a bench 9 of an open cut mine. After a drill string (not shown), comprising lengths of drill pipe and a cutting head, has been removed from within the bore hole 2, the operator feeds out the end 22 of the strip 20 to which the weight 30 is attached and through the opening 3 into the bore hole 2.

As illustrated in FIG. 7, the operator continues to feed out the strip 20 until the weight 30 at the end 22 reaches the bottom 5 of the bore hole 2 or reaches a point within the bore hole 2, such as the location of a major obstruction, that the weight 30 at the end 22 of the strip 20 cannot pass. The operator can then determine the depth of the bore hole 2, or the depth of the major obstruction, by reading the indicia 42 on the strip 20 that is closest to a lip 7 defining the opening 3 of the bore hole 2.

If the bore hole 2 is not yet at the required depth, or if there is a suspected obstruction, the operator may reinsert the drill string into the bore hole 2 to remove the obstruction or to continue drilling the bore hole 2 deeper to the required depth. The operator may the remove the drill string once and measure the depth of the bore hole 2 once again and so on until satisfied that the bore hole 2 has reached the desired depth and is not obstructed.

Once the desired depth for the bore hole 2 is reached and the operator is satisfied the bore hole 2 does not comprise any major obstructions, the drill string is removed and the operator moves on to the location at which the next bore hole 2 is to be drilled. In explosive operations, such as in open cut mining, the bore holes 2 are subsequently filled with bulk explosive material to form a column charge within the bore hole. A primer is located at the bottom 5 of the bore hole 2 and stemming material, such as aggregate, is provided to fill the top part of the bore hole 2 to cover the explosive charge. The primer is activated by an electrically or, non-electrically or electronic detonator or by some other means to thereby cause the explosive to detonate.

Embodiments of the invention are advantageous in that they ameliorate problems prevalent with existing dip tapes used to measure bore hole depth and/or to ensure no major obstructions. Because the material from which the strip 2 is comprised is relatively durable with a relatively high Young's modulus and/or because of the structural dimensions of the strip 20, the strip 20 is very resistant to becoming tangled and/or to getting caught in the bore hole 2 and/or from getting caught on any relatively minor obstructions within the bore hole 2 and/or from breaking and/or from wearing down with repeated use.

Furthermore, the structural properties of the strip 20, which are that it has a relatively high Young's modulus and/or because of the structural dimensions and/or because of the shape and configuration of the weight 30 attached to the end 22 of the strip or a combination of the aforementioned features, mean that the strip 20 can be effectively fed down to the bottom of the bore hole 20 relatively quickly and effectively and without getting caught on obstructions or in cracks in the wall of the bore hole 2 during insertion and/or during removal.

Although the disclosure has been described with reference to specific examples, it will be appreciated by those skilled in the art that the disclosure may be embodied in many other forms, in keeping with the broad principles and the spirit of the disclosure described herein.

1. An apparatus for measuring a depth of a bore hole, the apparatus including:
an elongated strip comprised of material that has an elastic (Young's) modulus of greater than 0.5 and less than 2.0 GPa (gigapascals);
a weight at an end of the strip; and
linear measurement markings along at least a portion of a length of the strip.

2. The apparatus of claim 1, wherein the material has an elastic (Young's) modulus of between 1.6 and 1.7 GPa (gigapascals).

3. The apparatus of claim 1, wherein the material has an elastic (Young's) modulus of between about 1.0 and 1.9 GPa (gigapascals) or between about 1.3 and 1.8 GPa (gigapascals).

4. The apparatus of claim 1, wherein the elongated strip comprises, in cross-section, a height of about 4mm and a width of about 14.5mm.

5. The apparatus of claim 1, wherein the measurement markings are comprised of indicia that are recessed into a surface of the strip.

6. The apparatus of claim 5, wherein the indicia are recessed by a depth of about 0.25 mm, or about 0.50 mm, or about 0.75 mm, or about 1.00, or about 1.25 mm, or about 1.50 mm, or any increment therebetween, into the surface of the strip.

7. The apparatus of claim 5, wherein the indicia are defined by a surface recessed within an outer surface of the strip.

8. The apparatus of claim 7, wherein the recessed surface is covered with a visible coating.

9. The apparatus of claim 1, wherein the weight is permanently fixed to the end of the strip.

10. The apparatus of claim 1, wherein the weight includes an elongated body comprising a distal end and a proximal end, wherein the proximal end includes a central opening extending longitudinally within the weight for receiving the end of the strip therewithin.

11. The apparatus of claim 10, wherein the strip includes one or more apertures for fixing the weight to the strip.

12. The apparatus of claim 11, wherein the one or more apertures in the strip engage with one or more detents located within the central opening of the weight.

13. The apparatus of claim 11, wherein the apertures in the strip receive fasteners for fixing the weight to the strip.

14. The apparatus of claim 11, wherein the material forming the weight is moulded into the one or more apertures in the strip thereby fixing the weight to the strip.

15. The apparatus of claim 10, wherein the proximal end and the distal end of the weight are rounded, wherein the rounding of the distal end has a larger radius than the rounding of the proximal end.

16. The apparatus of claim 1, wherein the weight is comprised of a soft metal, for example lead or an alloy with similar properties to lead.

17. The apparatus of claim 10, wherein the body of the weight is covered with a coating of material, preferably of plastic or of rubber or of rubber-like material.

18. A method of drilling a bore hole and of measuring a depth of the bore hole, the method including:
locating a drilling apparatus at the location of a bore hole to be drilled;
drilling a bore hole using a drill string of the drilling apparatus comprising an assembly of drill pipes and a cutting bit;
inserting a measuring apparatus into the bore hole including an elongated strip with a weight at and end of the strip, wherein the elongated strip is comprised of material that has an elastic (Young's) modulus of greater than 0.5 and less than 2.0 GPa (gigapascals); and
reading a depth of the bore hole by determining visually which one of a plurality of linear measurement markings along a length of the strip is located closest to a lip surrounding an opening of the bore hole.

19. The method of claim 18, wherein the measuring apparatus is inserted into the bore hole when the drill string is removed from the bore hole.
